(19) United States
(12) Patent Application Publication
(10) Pub. No.: US 2020/0001841 A1
(43) Pub. Date: Jan. 2, 2020

(54) SYSTEM AND METHOD FOR BRAKING A TRACTOR-TRAILER ASSEMBLY

(71) Applicant: CNH Industrial America LLC, New Holland, PA (US)

(72) Inventors: Brian Green, Downers Grove, IL (US); Ciro Mariniello, Formigine (IT); Haibo Guo, Naperville, IL (US); Shane P. Dillon, Naperville, IL (US); Jacob Charles, Lisle, IL (US); Vincenzo Corrado, Modena (IT)

(73) Assignee: CNH Industrial America LLC, New Holland, PA (US)

(21) Appl. No.: 16/023,429

(22) Filed: Jun. 29, 2018

(51) Int. Cl. B60T 8/17; B62D 53/00; B60T 1/06; B60T 8/171; B60T 8/172; B60T 8/18

(52) U.S. Cl. CPC B60T 8/1701; B62D 53/005; B60T 1/065; B60T 2250/02; B60T 8/172; B60T 8/18; B60T 2240/00; B60T 8/171

(57) ABSTRACT

A system and method for braking a tractor-trailer assembly is provided. The method includes generating a tractor brake pressure for application to a tractor brake for braking a tractor wheel, determining a tractor brake rate based on one or more of the generated tractor brake pressure, one or more parameters of the tractor brake, one or more parameters of the tractor wheel, one or more parameters of a final drive, and a mass of the tractor, and determining a trailer brake pressure applied to a trailer brake of a trailer wheel of a trailer, based on the determined tractor brake rate.

### BACKGROUND OF THE INVENTION

### 1. Field of the Invention

The present invention relates to braking systems and methods, and, more particularly, to systems and methods for braking tractor-trailer assemblies.

### 2. Description of the Related Art

Governing agencies and trade associations typically set braking standards for vehicles, such as, for example, vehicles in the form of tractor-trailer assemblies. Tractor-trailer assemblies include vehicles used for moving commerce, also simply referred to as tractor trailers, and vehicles used in connection with the agricultural industry, such as a tractor coupled to a trailer via a trailer hitch, tow bar, or other coupling devices, to enable the tractor to tow the trailer. Since such vehicular assemblies typically include braking circuitry for braking both the tractor and trailer, either independently or in some manner of coordination with one another, the assemblies are subject to jack-knifing and other motional instabilities due to having either no coordination between the tractor and trailer braking circuits, or insufficient or inaccurate coordination between the braking circuits, resulting in the assembly not meeting the braking requirements set by the regulating agencies or trade associations. Furthermore, even if the tractor-trailer assemblies manage to meet the governing braking requirements, the braking system of a conventional tractor-trailer assembly is not configured to determine and/or apply optimal values of braking parameters that also meet the braking requirements.

What is needed in the art is a system and method of braking tractor-trailer assemblies that meets one or more governing braking requirements and optimizes the braking performance to improve motional stability under braking, such as anti-jackknifing stability, as well as brake life.

### SUMMARY OF THE INVENTION

In accordance with an aspect of the present invention, a method for braking a tractor-trailer assembly includes depressing a brake pedal of a tractor for generating a tractor brake pressure applied to a tractor brake for braking a tractor wheel, the tractor brake coupled to the tractor wheel via a final drive, determining, by an electronic control unit (ECU), a tractor brake rate based on one or more of the generated tractor brake pressure, one or more parameters of the tractor brake, one or more parameters of the tractor wheel, one or more parameters of the final drive, and a mass of the tractor, and determining, by the ECU, a trailer brake pressure applied to a trailer brake of a trailer wheel of a trailer for braking the trailer wheel, based on the determined tractor brake rate.

In accordance with an aspect of the present invention, a braking system for use with a tractor-trailer assembly includes an electronic control unit (ECU) configured to: receive a brake signal from a brake pedal of a tractor of the tractor-trailer assembly representative of a tractor brake pressure applied to a tractor brake for braking a tractor wheel, the tractor brake coupled to the tractor wheel via a final drive; receive at least one of one or more parameters of the tractor brake, one or more parameters of the tractor wheel, one or more parameters of the final drive, and a mass of the tractor; determine a tractor brake rate based on one or more of the received brake signal, the received one or more parameters of the tractor brake, the received one or more parameters of the tractor wheel, the received one or more parameters of the final drive, and the received mass of the tractor; and determine a trailer brake pressure applied to a trailer brake of a trailer wheel of a trailer of the tractor-trailer assembly for braking the trailer wheel, based on the determined tractor brake rate.

In accordance with an aspect of the present invention, a tractor-trailer braking system includes a tractor having a brake pedal for producing a tractor brake pressure, a tractor brake configured for receiving the tractor brake pressure, a final drive coupled to the tractor brake, and a tractor wheel coupled to the final drive; and a trailer coupled to the tractor, the trailer including a trailer brake and a trailer wheel coupled to the trailer brake. The tractor also includes a trailer brake valve coupled to the trailer brake, and an electronic control unit (ECU) configured to receive a brake signal from the brake pedal of the tractor representative of the tractor brake pressure applied to the tractor brake for braking the tractor wheel, receive at least one of one or more parameters of the tractor brake, one or more parameters of the tractor wheel, one or more parameters of the final drive, and a mass of the tractor, determine a tractor brake rate based on one or more of the received brake signal, the received one or more parameters of the tractor brake, the received one or more parameters of the tractor wheel, the received one or more parameters of the final drive, and the received mass of the tractor, determine a trailer brake pressure based on the determined tractor brake rate, and generate a trailer brake valve control signal based on the determined trailer brake pressure. The tractor further includes a trailer brake ECU, wherein the trailer brake ECU is configured to receive the trailer brake valve control signal and a piloted tractor brake pressure, and adjust the piloted pressure based on the control signal for generating the determined trailer brake pressure for application to the trailer brake of the trailer wheel for braking the trailer wheel.

An advantage of the present invention is to adjust a present trailer brake pressure applied to a trailer brake of a trailer wheel based on a determined tractor brake rate, where the trailer brake pressure as adjusted falls within a range of acceptable trailer brake pressures as determined by braking standards or implemented regulations for reducing anti-knifing and improving tractor brake life.

Another advantage of the present invention is to adjust a present trailer brake pressure applied to a trailer brake of a trailer wheel based on a determined tractor brake rate, where the trailer brake pressure is adjusted to have an optimized value for preventing anti-knifing and improving tractor brake life.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a tractor-trailer assembly, according to an embodiment of the present invention;

FIG. 2 is a schematic drawing of a braking system for use with the tractor-trailer assembly of FIG. 1, according to an embodiment of the present invention;

FIG. 3 illustrates a brake frictional plate of the braking system of FIG. 2, according to an embodiment of the present invention;

FIG. 4 illustrates a tire mounted to the wheel of the braking system of FIG. 2, according to an embodiment of the present invention;

FIG. 5 depicts graphs showing trailer brake pressures that are within acceptable ranges for both pneumatic- and hydraulic-implementation of the braking system of FIG. 2 as a function of tractor brake rates for both unladen and laden tractors, according to an embodiment of the present invention;

FIG. 6 is a schematic drawing of a braking system for use with the tractor-trailer assembly of FIG. 1, according to another embodiment of the present invention; and

FIG. 7 illustrates a method for braking a tractor-trailer assembly, according to an embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

The terms “fore”, “aft”, “left” and “right”, when used in connection with a vehicle assembly and/or components thereof are usually determined with reference to the direction of forward operative travel of the vehicle assembly, but they should not be construed as limiting. The terms “longitudinal” and “transverse” are determined with reference to the fore-and-aft direction of the vehicle assembly and are equally not to be construed as limiting.

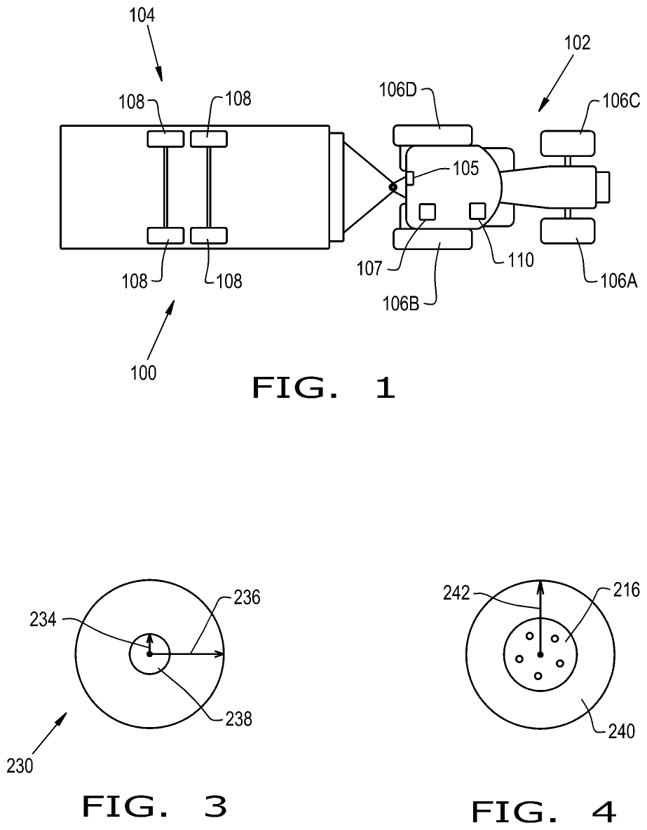

Referring now to the drawings, and more particularly to FIG. 1, there is shown an exemplary embodiment of a vehicle assembly 100 in the form of a tractor-trailer assembly 100, according to the present invention. The tractor-trailer assembly 100 includes a tractor 102 and a trailer 104. In one embodiment, the tractor 102 and the trailer 104 are mechanically coupled together, for example with a towing joint, or other well know coupling assemblies, such as a quick coupler 105 that may include electrical and/or hydraulic connections. For example, the quick coupler 105 may include an ISOBus. The tractor 102 includes tractor wheels 106 and the trailer 104 includes trailer wheels 108. Although the trailer 104, as illustrated, is a dual axel trailer having four trailer wheels 108, the scope of the present invention includes the trailer 104 having only a single axle with two trailer wheels 108. Furthermore, the tractor 102 includes a at least one brake pedal 110 configured to be depressed by an operator of the tractor 102 for generating a brake pressure for use in braking one or more of the tractor wheels 106 and piloted for use in braking one or more of the trailer wheels 108 of the trailer 104. In one embodiment, the tractor 102 includes the quick coupler 105 and an electronic control unit (ECU) 107. The ECU 107 will be discussed further below in more detail.

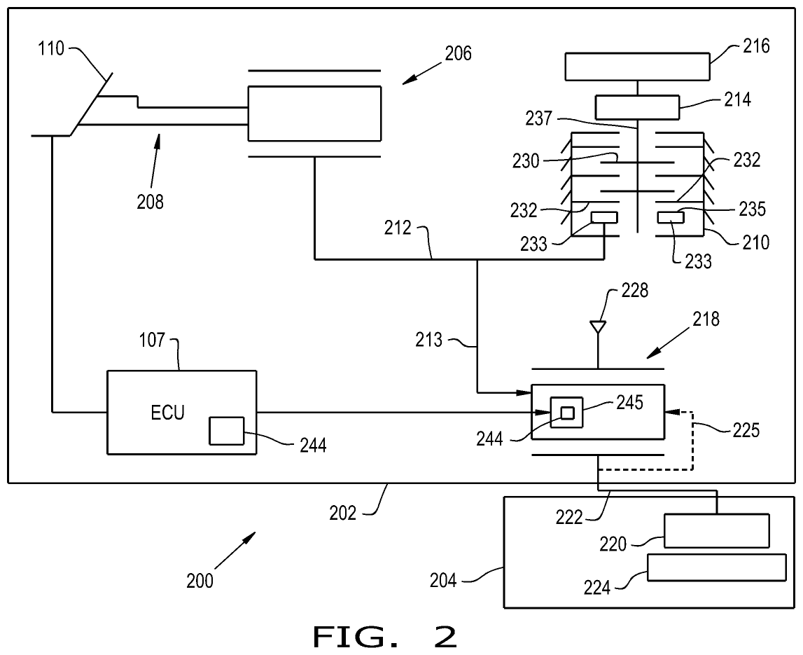

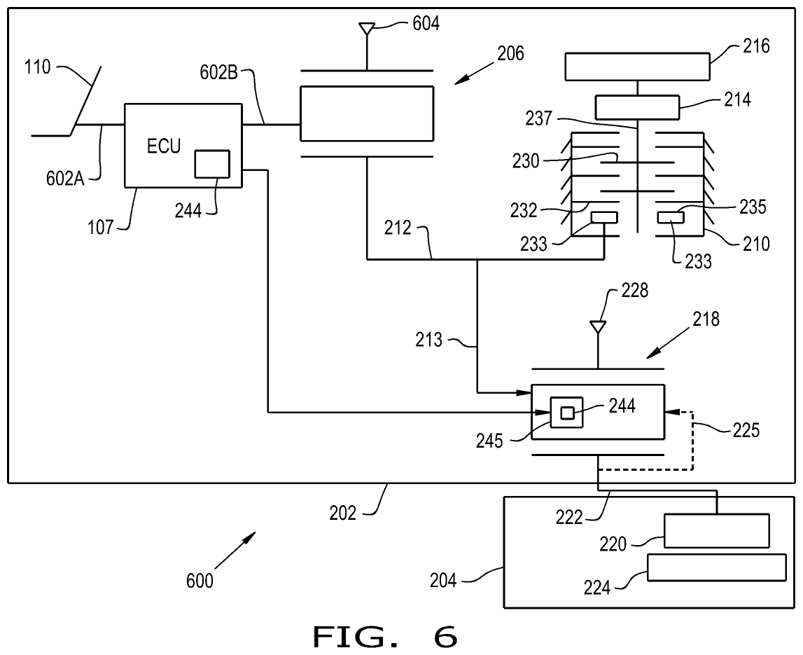

FIG. 2 is a schematic drawing of a braking system 200 for use with the tractor-trailer assembly 100 of FIG. 1, according to an embodiment of the present invention. As illustrated, the braking system 200 includes a tractor braking section 202 (also referred to as tractor braking circuitry) and a trailer braking section 204 (also referred to as trailer braking circuitry). The tractor braking section 202 includes the brake pedal 110, a master cylinder 206 (also referred to as a tractor brake valve) mechanically coupled to the brake pedal 110 via a mechanical coupling 208 such as a rod linkage assembly (or electrically coupled to the brake pedal as discussed further below in conjunction with the FIG. 6), a tractor brake 210 coupled to the master cylinder 206 via a brake line 212 (e.g., a hydraulic brake line), a final drive 214 coupled to the tractor brake 210, and a tractor wheel 216 coupled to the final drive 214. In one embodiment of the invention, the tractor wheel 216 corresponds to one of the two rear tractor wheels 106B, 106D (FIG. 1) of the tractor 102, however the scope of the invention covers a tractor braking section 202 configured for breaking all four tractor wheels 106A, 106B, 106C, 106D, or a tractor braking section 202 having two brake pedals 110, one for braking either the left rear tractor wheel 106D or the left tractor wheels 106C, 106D, and the other for braking the right rear tractor wheel 106B or the right tractor wheels 106A, 106B. Although not depicted by FIG. 2 for reasons of ease of illustration, the scope of invention covers the pedal 110 configured to brake both rear tractor wheels 106B, 106D via the brake line 212.

The brake pedal 110, when depressed, actuates the master cylinder 206 to generate a tractor brake pressure (e.g., a hydraulic tractor brake pressure) in the brake line 212 for activating the tractor brake 210. The tractor brake 210 brakes the rear axle 237, and the final drive 214 couples the braking action on the rear axle 237 to a braking action on the tractor wheel 216 (e.g., on the rear wheels 106B, 106D). Braking assemblies including final drives and wheels are well known and will not be described in further detail.

The tractor braking section 202 also includes a trailer brake valve 218 coupled to the master cylinder 206 via a pilot brake line 213 for piloting the tractor break pressure to the trailer break valve 218 and the ECU 107 configured to receive a brake signal from the brake pedal 110 of the tractor 102 that is representative of the tractor brake pressure applied to the tractor brake 210 for braking the tractor wheel 216. In one embodiment of the invention, the brake signal is an electrical signal generated by a transducer (not shown), such as an electromechanical sensor coupled between the mechanical linkage 208 of the brake pedal 110 and the ECU 107, as is known in the art.

The trailer braking section 204 includes a trailer brake 220 and a trailer wheel 224 (e.g., one of the trailer wheels 108 of FIG. 1) coupled to the trailer brake 220. The trailer brake 220 is coupled to the trailer brake valve 218 via a trailer brake line 222. In one embodiment of the invention, the trailer brake valve 218 is coupled to each trailer wheel 108 via corresponding trailer brakes 220, but for ease of illustration, only one trailer wheel 224 is depicted in FIG. 2. The trailer breaking section 204 may optionally include a feedback circuit 225 configured to feedback the pressure in the trailer brake line 222 to the trailer brake valve 218 for refining adjustments of the trailer brake valve 218 to maintain an appropriate pressure in the trailer break line 222.

The ECU 107 is also configured to receive at least one of one or more parameters of the tractor brake 210, one or more parameters of the tractor wheel 216, one or more parameters of the final drive 214 and a mass of the tractor 102, determine a tractor brake rate based on one or more of the received parameters, the mass of the tractor and the brake signal, and generate a trailer brake valve control signal based at least on the determined tractor brake rate for controlling the trailer brake valve 218 to generate an appropriate and/or optimized trailer break pressure (e.g., to adjust a present trailer break pressure) being applied to the one or more trailer brakes 220 of the trailer 104, as described in more detail further below.

In one embodiment of the invention, upon activation of the tractor brake 210 the tractor brake pressure is piloted to the trailer brake valve 218 via the pilot brake line 213. The trailer brake valve 218 also receives the trailer break valve control signal from the ECU 107 for controlling application of the piloted tractor brake pressure to the trailer brake valve 218 for adjusting (or setting) the trailer brake pressure in the trailer brake line 222 to the appropriate and/or optimized pressure for activating the one or more trailer brakes 220. In another embodiment of the invention, the trailer braking section 204 includes a source of trailer brake pressure 228 (e.g., a trailer brake pump) configured to receive the trailer brake valve control signal from the ECU 107 for adjusting (or setting) the trailer brake pressure in the trailer brake line 222 to the appropriate and/or optimized pressure for activating the one or more trailer brakes 220. In one embodiment, the source of trailer brake pressure 228 can maintain a pressure in the trailer brake line 222.

In one embodiment of the present invention, the ECU 107 is configured to determine the tractor brake rate by first determining a brake torque applied to the tractor brake 210 based on the received brake signal and parameters of the tractor brake 210. FIG. 2 shows the tractor brake 210 including one or more brake frictional plates 230, one or more steel plates (sometimes referred to as separate plates) 232 coupled to a housing or chassis (not shown) of the tractor 102, and a piston 233 (having a cross-section area A 235) configured to receive the tractor brake pressure and apply the tractor brake pressure (via the one or more steel plates 232 or alternatively via the one or more steel plates 232 in combination with one or more brake pads (not shown), for example) to the brake frictional plates 230. FIG. 3 illustrates an exemplary embodiment of the brake frictional plate 230 having an inner radius 234 and an outer radius 236 (i.e., radii). An axle 237 (FIG. 2) (e.g., a rear axle) of the tractor 102 may pass through the space 238 defined by the inner radius 234 of the brake frictional plate 230, and the brake fictional plate 230 may be secured or otherwise mounted via fastening hardware to the axle 237.

In one embodiment, the ECU 107 is configured to determine the brake torque applied to the tractor brake 210 based the received brake signal and a number N of the one or more brake frictional plates 230, the radii 234, 238 of the one or more brake frictional plates 230, the piston area A 235, and a coefficient of friction i between the one or more brake frictional plates 230 and the one or more steel plates 232. For example, in one embodiment, the ECU 107 determines the brake torque T_{brake} applied to the tractor brake 210, where

$${T}_{brake} = μ * N * ( \frac{2}{3} * \frac{( {R}_{ext}^{3} - {R}_{int}^{3} )}{( {R}_{ext}^{2} - {R}_{int}^{2} )} ) * P * A$$

and Rᵢₙₜ is the inner radius 234, Rₑₓₜ is the outer radius 238, and P is the tractor brake pressure, which may also be represented by the brake signal received by the ECU 107 from the brake pedal 110.

The ECU 107 is further configured to determine a wheel torque applied to the tractor wheel 216 based on a gear ratio Z of the final drive 214 and the determined brake torque. For example, in one embodiment the ECU 107 is configured to determine a wheel torque T_{wheel}, where T_{wheel}=T_{brake}*Z, and Z is the gear ratio of the final drive 214 between the tractor brake 210 and the tractor wheel 216. However, the scope of the invention covers embodiments in which the final drive 214 between the tractor brake 210 and the tractor wheel 216 is not present, and thus the gear ratio Z=1.

In addition, the ECU 107 is configured to determine a brake force F_{bf} on the tire of the wheel (also referred to as the brake force on the wheel), where F_{bf}=T_{wheel}/RR, and RR is the tire rolling radius. FIG. 4 illustrates a tire 240 mounted to the wheel 216, and RR 242 is the tire rolling radius.

Furthermore, the ECU 107 is configured to determine a tractor brake rate BR based on the mass of the tractor 102 and the determined brake force, where BR=F_{bf}/Fᵥ, and Fᵥ is the static vertical force on the tractor wheel 216, which is dependent upon the mass of the tractor 102. For example, if the four wheels 106 of the tractor 102 are located the same distance from the center of mass of the tractor 102, then the static vertical force Fᵥ on each wheel 106 of the tractor is (M*g)/4. However, one of skill in the art knows how to calculate the static vertical force Fᵥ on a tractor rear wheel (e.g., rear wheel 106B or 106D) given the mass of the tractor 102, the number of wheels, and the location of each of the wheels relative to a location of the center of mass. In another embodiment of the invention, an approximation to the static vertical force Fᵥ on a rear tractor wheel 106B or 106D may be used in which the total weight of the tractor 102 is approximated as resting on the rear two wheels 106B, 106D, and thus Fᵥ may be approximated as (M*g)/2.

In another embodiment of the invention, the ECU 107 is configured to determine a trailer brake pressure based on the brake signal (which is representative of the piloted pressure) and a value of an adjustable trailer brake valve pressure ratio. Typical trailer brake valves are configured to generate a pressure in a trailer brake line based on the configuration of the valve and the received piloted pressures. For example, for a received piloted pressure, a conventional trailer brake valve will generate a trailer brake line pressure, where the ratio of the generated pressure to the piloted pressure, defined to be the trailer brake valve pressure ratio, could be constant, or in some instances variable.

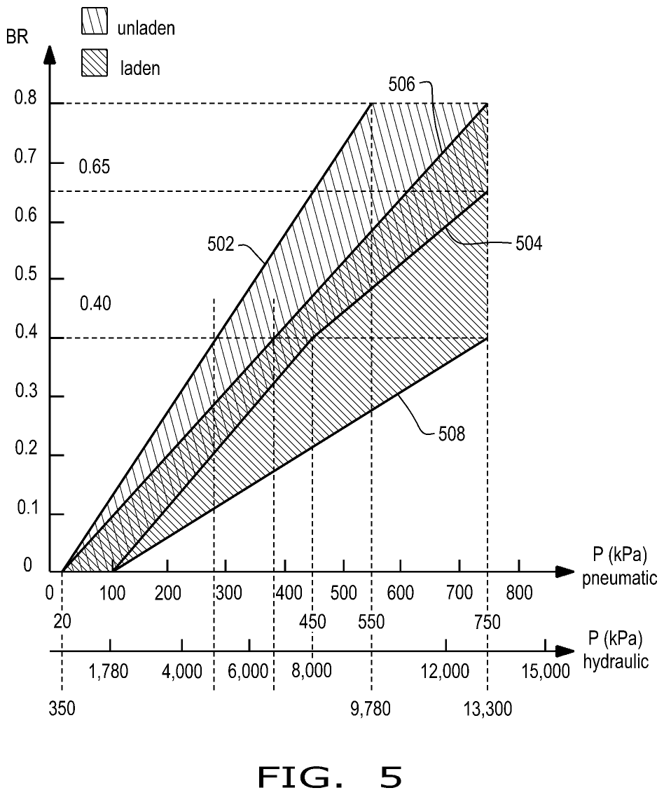

Furthermore, the ECU 107 is configured to determine whether the determined present trailer brake pressure is within a requirement region between a lower-bounded trailer brake pressure and an upper-bounded trailer brake pressure, wherein each of the lower-bounded and upper-bounded trailer brake pressures are dependent upon the determined tractor brake rate and upon whether the tractor is laden or unladen, as described further below in conjunction with FIG. 5.

FIG. 5 illustrates trailer brake pressures (horizontal axis) that are within acceptable ranges for both pneumatic- and hydraulic-implemented braking systems 200 as a function of tractor brake rates BR (vertical axis) for both unladen and laden tractors, according to an embodiment of the present invention. A laden tractor has additional mass (i.e., ballast) typically added to a front portion of an unladen tractor. Typically, ballast is added to tractors to improve and/or stabilize steering and/or to improve traction when the tractor is operating under heavy load.

As illustrated by FIG. 5, line 502 forms a lower bound and line 504 forms an upper bound for acceptable trailer brake pressures for an unladen tractor as a function of tractor brake rate BR. The term “line,” as used in this description, is not necessarily a straight line, but may be formed of two or more straight-line segments. As further illustrated by FIG. 5, line 506 forms a lower bound and line 508 forms an upper bound for acceptable trailer brake pressures for a laden tractor as a function of tractor brake rate, BR.

In one embodiment of the invention, “acceptable” trailer brake pressures are defined to be those trailer brake pressures that are between the lower-bounded trailer brake pressure and the upper bounded trailer brake pressure, for a given tractor brake rate and a given state of ballast (i.e., laden or unladen), that conform to standards and/or regulations implemented by governmental agencies or trade associations, for example. In other words, the acceptable trailer brake pressures, for a given state of ballast, are those pressures that generate the tractor brake rates within the bounds of the tractor-trailer system 100 during deceleration.

In one embodiment of the present invention, the ECU 107 determines trailer brake valve characteristics so that the trailer brake pressure is within the lower-bounded trailer brake pressure and the upper-bounded trailer brake pressure for the given tractor state, such as state of ballast of the tractor 102. The ECU 107 adjusts (or sets) the trailer brake pressure to have a value between the lower-bounded trailer brake pressure and the upper-bounded trailer brake pressure by controlling the trailer brake valve 218 to adjust (or set) the trailer brake pressure to the trailer brake 220 for braking the trailer wheel 224. For example, in one embodiment, the ECU 107 generates a trailer brake valve control signal based on the trailer brake pressure being adjusted (or set) to have a value between the lower-bounded trailer brake pressure and the upper-bounded trailer brake pressure, and sends the control signal to the trailer brake valve 218.

In one embodiment, the trailer brake valve 218 is configured, via a trailer brake ECU 245 (FIG. 2), to have an adjustable trailer brake valve pressure ratio. For example, the trailer brake ECU 245 may be configured to adjust (or set), in response to the received control signal, the resistance of a trailer brake cylinder piston (not shown) of the trailer brake valve 218 to the piloted pressure for generating the acceptable trailer brake pressure as determined by the ECU 107 (i.e., for adjusting (or setting) the trailer brake pressure to have the value between the lower-bounded trailer brake pressure and the upper-bounded trailer brake pressure). Although the trailer brake ECU 245 is shown integrated with the trailer brake valve 218, the trailer brake ECU 245 may be formed as a discrete, separate component located between the ECU 107 and the trailer brake valve 218.

Thus, for example, and in reference to FIG. 5 as applied to a pneumatic braking system 200, if the ECU 107 determines that the brake rate is 0.40 for an unladen tractor, the ECU 107 determines that the trailer brake pressure is within the lower-bounded pressure of 280 kPa and the upper-bounded brake pressure of 450 kPa. For example, the ECU 107 may generate a trailer brake valve control signal for setting the trailer brake pressure via the trailer brake ECU 245. By way of another exemplary example, if the ECU 107 determines that the brake rate is 0.40 for a laden tractor, the ECU 107 determines that the trailer brake pressure is within the lower-bounded pressure of 380 kPa and the upper-bounded brake pressure of 750 kPa.

In another embodiment of the invention, the ECU 107 further determines the trailer brake pressure to be approximately equal to the upper-bounded trailer brake pressure for a given determined tractor brake rate and given state of ballast of the tractor 102. The ECU 107 is further configured to control the trailer brake valve 218 to adjust (or set) the trailer brake pressure to have a value that is approximately equal to the upper-bounded trailer brake pressure. For example, the ECU 107 may generate and send a trailer brake valve control signal to the trailer brake ECU 245 that causes the trailer brake valve 218 to generate a trailer brake pressure having a value approximately equal to the upper-bounded trailer brake pressure.

For example, when the tractor 102 is laden, the upper-bounded trailer brake pressure, which may be represented by line 508, is

$${P}_{trailer} = 16.25 [ \frac{{F}_{bf}}{{M}_{laden}} + \frac{{R}_{f}}{g} ] + 1$$

wherein M_{laden} is a laden mass of the tractor, g is acceleration due to gravity, Rᵣ is a tire rolling resistance of the tractor wheel, and F_{bf} is the tractor brake force. The upper-bounded trailer brake pressure, for laden and unladen tractors, represents an optimized set of braking parameters for maximizing tractor-trailer assembly 100 braking performance in the sense of minimizing the jackknifing risk between tractor 102 and trailer 104 and improving brake life, according to an embodiment of the present invention. For example, and in reference to FIG. 5, if the tractor is laden and if the ECU 107 determines that the tractor brake rate is 0.65, then the ECU 107 determines that the optimized trailer brake pressure is 750 kPA for a pneumatic-implemented braking system 200 and 13,300 kPa for a hydraulic-implemented braking system 200.

In an embodiment of the invention, the ECU 107 and/or the ECU 245 includes a memory 244 configured to store one or more parameters of the tractor brake, one or more parameters of the tractor wheel, one or more parameters of the final drive, the mass (unladen and laden) of the tractor 102 and/or one or more equations and/or graphs (such as the FIG. 5 graph) representing the functional relationship between a tractor brake rate BR and acceptable and/or optimized trailer brake pressure Pₜᵣₐᵢₗₑᵣ. In one embodiment of the present invention, the acceptable range of trailer brake pressures represented by one or more equations and/or graphs will meet the governing regulations/standards that may be required by trade associations or governing agencies in various countries or sovereignties.

FIG. 6 is a schematic drawing of a braking system 600 for use with the tractor-trailer assembly 100 of FIG. 1, according to another embodiment of the present invention. The braking system 600 is similar to the braking system 200 of FIG. 2, with the same reference numbers designating the same elements. However, in contrast to the braking system 200, the ECU 107 of the braking system 600 couples the brake pedal 110 to the master cylinder 206 via electrical lines 602, thereby replacing the mechanical coupling 208 of the braking system 200. In the FIG. 6 embodiment, the ECU 107 receives the brake signal from the brake pedal 110 over the electrical line 602A when the brake pedal 110 is depressed, generates a master cylinder control signal based on the received brake signal, and sends the master cylinder control signal to the master cylinder 206 over electrical line 602B for controlling a source of tractor brake pressure 604 for generating a corresponding tractor brake pressure in the braking line 212.

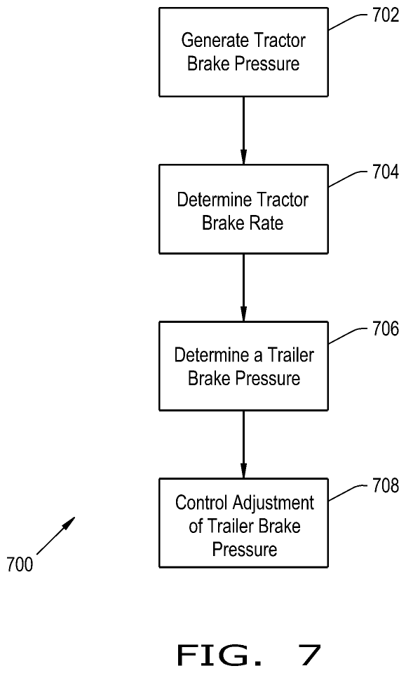

FIG. 7 illustrates a method 700 for braking a tractor-trailer assembly, according to an embodiment of the present invention. In step 702, a tractor brake pressure is generated. In one embodiment, a brake pedal of a tractor is depressed for generating the tractor brake pressure, either mechanically or electrically, which is applied to a tractor brake for braking a tractor wheel. The tractor brake is coupled to the tractor wheel via a final drive.

In step 704, a tractor brake rate is determined based on one or more of the generated tractor brake pressure, one or more parameters of the tractor brake, one or more parameters of the tractor wheel, one or more parameters of the final drive, and a mass of the tractor. In one embodiment, an ECU determines the tractor brake rate.

In step 706, a trailer brake pressure is determined which is applied to a trailer brake of a trailer wheel of a trailer for braking the trailer wheel, based on the determined tractor brake rate. For example, in one embodiment, the ECU determines the trailer brake pressure is within a lower-bounded trailer brake pressure and an upper-bounded trailer brake pressure, wherein each of the lower-bounded and upper-bounded trailer brake pressures are dependent upon the determined tractor brake rate and upon whether the tractor is laden or unladen.

In another embodiment, the ECU determines the trailer brake pressure to have a value approximately equal to the upper-bounded trailer brake pressure. The ECU then controls, in step 708, an adjustment (or setting) of the trailer brake pressure to have a value approximately equal to the upper-bounded trailer brake pressure.

Although in one embodiment, the tractor-trailer system 100 includes two separate ECUs (i.e., ECU 107 and the trailer brake ECU 245), the scope of the invention covers a single ECU (e.g., ECU 107) having the additional functionalities of the trailer brake ECU 245.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for braking a tractor-trailer assembly, the method comprising:
depressing a brake pedal of a tractor for generating a tractor brake pressure applied to a tractor brake for braking a tractor wheel, the tractor brake coupled to the tractor wheel via a final drive;
determining, by an electronic control unit (ECU), a tractor brake rate based on one or more of the generated tractor brake pressure, one or more parameters of the tractor brake, one or more parameters of the tractor wheel, one or more parameters of the final drive, and a mass of the tractor; and
determining, by the ECU, a trailer brake pressure applied to a trailer brake of a trailer wheel of a trailer for braking the trailer wheel based on the determined tractor brake rate.

2. The method according to claim 1, wherein the tractor brake comprises one or more brake frictional plates, one or more steel plates, and a brake piston, and wherein determining the tractor brake rate further comprises:
determining, by the ECU, a brake torque applied to the tractor brake based on a number of the one or more brake frictional plates, radii of the one or more brake frictional plates, an area of the piston, a coefficient of friction between the one or more brake frictional plates and the one or more steel plates, and the tractor brake pressure;
determining, by the ECU, a wheel torque applied to the tractor wheel based on a gear ratio Z of the final drive and the determined brake torque;
determining, by the ECU, a brake force applied to the tractor wheel based on a tire rolling radius of the tractor wheel and the determined wheel torque; and
determining, by the ECU, the tractor brake rate based on the mass of the tractor and the determined brake force.

3. The method according to claim 1, further comprising:
piloting the generated tractor break pressure to a trailer brake valve of the trailer brake;
receiving, by the ECU, a brake signal from the brake pedal representative of the generated tractor brake pressure; and
determining, by the ECU, a trailer brake pressure to have a value between a lower-bounded trailer brake pressure and an upper-bounded trailer brake pressure based on the brake signal, wherein each of the lower-bounded and upper-bounded trailer brake pressures are dependent upon the determined tractor brake rate and upon whether the tractor is laden or unladen.

4. The method according to claim 3, further comprising:
generating, by the ECU, a trailer brake valve control signal based on the determined trailer brake pressure;
receiving, by a trailer brake ECU, the trailer brake valve control signal; and
generating, by the trailer brake ECU, the determined trailer brake pressure based on the received trailer brake valve control signal and the piloted generated tractor brake pressure.

5. The method according to claim 4, further comprising adjusting, by the trailer brake ECU, a trailer brake valve pressure ratio based on the received control signal.

6. The method according to claim 3, wherein determining, by the ECU, the trailer brake pressure to have a value between the lower-bounded trailer brake pressure and the upper-bounded trailer brake pressure further comprises:
determining, by the ECU, the trailer brake pressure to have a value approximately equal to the upper-bounded trailer brake pressure;
generating, by the ECU, a trailer brake valve control signal based on the determined trailer brake pressure;
receiving, by a trailer brake ECU, the trailer brake valve control signal; and
generating, by the trailer brake ECU, the determined trailer brake pressure based on the received trailer brake valve control signal and the piloted generated tractor brake pressure.

7. The method according to claim 6, wherein when the tractor is laden, the upper-bounded trailer brake pressure is P=(16.25/M_{laden})×F_{bf}+(16.25/g)×Rᵣ+1, wherein M_{laden} is a laden mass of the tractor, g is acceleration due to gravity, Rᵣ is a tire rolling resistance of the tractor wheel, and F_{bf} is the tractor brake force.

8. The method according to claim 1, wherein the ECU includes a memory configured for storing the one or more parameters of the tractor brake, the one or more parameters of the tractor wheel, the one or more parameters of the final drive, and the mass of the tractor, wherein the method further comprises receiving, by the ECU, a brake signal from the brake pedal representative of the generated tractor brake pressure, and wherein determining the tractor brake rate further comprises determining the tractor brake rate based on one or more of the one or more stored parameters of the tractor brake, the one or more stored parameters of the tractor wheel, the one or more stored parameters of the final drive, the stored mass of the tractor, and the received brake signal.

9. A braking system for use with a tractor-trailer assembly, the system comprising:
an electronic control unit (ECU) configured to:
receive a brake signal from a brake pedal of a tractor of the tractor-trailer assembly representative of a tractor brake pressure applied to a tractor brake for braking a tractor wheel, the tractor brake coupled to the tractor wheel via a final drive;
receive at least one of one or more parameters of the tractor brake, one or more parameters of the tractor wheel, one or more parameters of the final drive, and a mass of the tractor;
determine a tractor brake rate based on one or more of the received brake signal, the received one or more parameters of the tractor brake, the received one or more parameters of the tractor wheel, the received one or more parameters of the final drive, and the received mass of the tractor; and
determine a trailer brake pressure applied to a trailer brake of a trailer wheel of a trailer of the tractor-trailer assembly for braking the trailer wheel based on the determined tractor brake rate.

10. The braking system according to claim 9, wherein the tractor brake comprises one or more brake frictional plates, one or more steel plates, and a brake piston, and wherein the ECU is further configured to:
determine a brake torque applied to the tractor brake based on a number of the one or more brake frictional plates, radii of the one or more brake frictional plates, an area of the piston, a coefficient of friction between the one or more brake frictional plates and the one or more steel plates, and the received brake signal;
determine a wheel torque applied to the tractor wheel based on a gear ratio Z of the final drive and the determined brake torque;
determine a brake force applied to the tractor wheel based on a tire rolling radius of the tractor wheel and the determined wheel torque; and
determine the tractor brake rate based on the mass of the tractor and the determined brake force.

11. The braking system according to claim 9, wherein the ECU is further configured to:
determine the trailer brake pressure to have a value between a lower-bounded trailer brake pressure and an upper-bounded trailer brake pressure, wherein each of the lower-bounded and upper-bounded trailer brake pressures are dependent upon the determined tractor brake rate and upon whether the tractor is laden or unladen;
generate a trailer brake valve control signal based on the determined trailer brake pressure; and
send the trailer brake valve control signal to a trailer brake ECU for generating the determined trailer brake pressure.

12. The braking system according to claim 11, wherein the ECU is further configured to determine the trailer brake pressure to have a value approximately equal to the upper-bounded trailer brake pressure.

13. The braking system according to claim 12, wherein when the tractor is laden, the upper-bounded trailer brake pressure is P=(16.25/M_{laden})×F_{bf}+(16.25/g)×Rᵣ+1, wherein M_{laden} is a laden mass of the tractor, g is acceleration due to gravity, Rᵣ is a tire rolling resistance of the tractor wheel, and F_{bf} is the tractor brake force.

14. The braking system according to claim 9, wherein the ECU includes a memory configured for storing the one or more parameters of the tractor brake, the one or more parameters of the tractor wheel, the one or more parameters of the final drive, and the mass of the tractor.

15. A tractor-trailer braking system, comprising:
a tractor including a brake pedal for producing a tractor brake pressure, a tractor brake configured for receiving the tractor brake pressure, a final drive coupled to the tractor brake, and a tractor wheel coupled to the final drive; and
a trailer coupled to the tractor, the trailer including a trailer brake and a trailer wheel coupled to the trailer brake, wherein
the tractor further includes:
a trailer brake valve coupled to the trailer brake; and
an electronic control unit (ECU) configured to:
receive a brake signal from the brake pedal of the tractor representative of the tractor brake pressure applied to the tractor brake for braking the tractor wheel;
receive at least one of one or more parameters of the tractor brake, one or more parameters of the tractor wheel, one or more parameters of the final drive, and a mass of the tractor;
determine a tractor brake rate based on one or more of the received brake signal, the received one or more parameters of the tractor brake, the received one or more parameters of the tractor wheel, the received one or more parameters of the final drive, and the received mass of the tractor;
determine a trailer brake pressure based on the determined tractor brake rate; and
generate a trailer brake valve control signal based on the determined trailer brake pressure, wherein the tractor further includes a trailer brake ECU, and wherein the trailer brake ECU is
configured to receive the trailer brake valve control signal and a piloted tractor brake pressure, and adjust the piloted pressure based on the control signal for generating the determined trailer brake pressure for application to the trailer brake of the trailer wheel for braking the trailer wheel.

16. The tractor-trailer braking system according to claim 15, wherein
the tractor brake includes one or more brake frictional plates, one or more steel plates, and a brake piston, and wherein
the ECU is further configured to:
determine a brake torque applied to the tractor brake based on a number of the one or more brake frictional plates, radii of the one or more brake frictional plates, an area of the piston, a coefficient of friction between the one or more brake frictional plates and the one or more steel plates, and the received braking signal;
determine a wheel torque applied to the tractor wheel based on a gear ratio Z of the final drive and the determined brake torque;
determine a brake force applied to the tractor wheel based on a tire rolling radius of the tractor wheel and the determined wheel torque; and
determine the tractor brake rate based on the mass of the tractor and the determined brake force.

17. The tractor-trailer braking system according to claim 15, wherein the ECU is further configured to:
determine the trailer brake pressure to have a value between a lower-bounded trailer brake pressure and an upper-bounded trailer brake pressure, wherein each of the lower-bounded and upper-bounded trailer brake pressures are dependent upon the determined tractor brake rate and upon whether the tractor is laden or unladen.

18. The tractor-trailer braking system according to claim 17, wherein the ECU is further configured to determine the trailer brake pressure to have a value approximately equal to the upper-bounded trailer brake pressure.

19. The tractor-trailer braking system according to claim 18, wherein when the tractor is laden, the upper-bounded trailer brake pressure is P=(16.25/M_{laden})×F_{bf}+(16.25/g)×Rᵣ+1, wherein M_{laden} is a laden mass of the tractor, g is acceleration due to gravity, Rᵣ is a tire rolling resistance of the tractor wheel, and F_{bf} is the tractor brake force.

20. The tractor-trailer braking system according to claim 15, wherein the ECU includes a memory configured for storing the one or more parameters of the tractor brake, the one or more parameters of the tractor wheel, the one or more parameters of the final drive, and the mass of the tractor.
